(19) United States
(12) Patent Application Publication
(10) Pub. No.: US 2012/0046383 A1
(43) Pub. Date: Feb. 23, 2012

(54) SILICONE RUBBER COMPOSITION

(75) Inventors: Stephen H. Spiegelberg, Winchester, MA (US); Martin F. van Buren, Chelmsford, MA (US)

(73) Assignee: Terumo Kabushiki Kaisha, Shibuya-ku (JP)

(21) Appl. No.: 12/859,441

(22) Filed: Aug. 19, 2010

(51) Int. Cl. C08K 5/1545; B65D 55/02

(52) U.S. Cl. 523/113; 53/425

(57) ABSTRACT

The silicone rubber composition disclosed here is formed a configuration in which vitamin E or a derivative thereof, or a salt of any one thereof is dispersed at least at a portion of the silicone rubber. Also disclosed is a method of manufacturing a medical apparatus that involves mixing a silicone rubber precursor with vitamin E or a derivative thereof, or a salt of any one thereof and hardening the obtained mixture, or a process of infiltrating a silicone rubber into vitamin E or a derivative thereof, or a salt of any one thereof in a liquid state. Further, the method of manufacturing a medical apparatus as disclosed here includes installing the obtained silicone rubber composition onto a medical apparatus; hermetically packaging the obtained medical apparatus; and irradiating radiation to the hermetically packaged medical apparatus.

### TECHNICAL FIELD

Provided is a silicone rubber composition. In more detail, provided is a silicone rubber composition which can be used suitably for a medical apparatus in which radiation sterilization is executed.

### BACKGROUND DISCUSSION

Silicone rubber is widely used as an elastic material and a fiber material in a medical apparatus.

For example, Japanese Examined Patent Publication No. S02-949 discloses a tubular-body introducer for medical treatment which is used when introducing a long sized member for medical treatment such as a catheter, a guide wire and the like into the inside of a living body. The aforesaid introducer includes a main body which forms a tubular shape, a cap provided at one terminal of the main body, and a valve body which is positioned on the pathway inside the tube of the main body and which is fixed in a state of being sandwiched by the main body and the cap.

The valve body has a slit at a center portion thereof, and the aforesaid slit becomes in a state of being opened when a catheter or the like is inserted into the main body and becomes in a state of being closed when it is decannulated, and thereby prevents outward flow of blood. In this manner, the valve body which needs to be opened and closed flexibly along with the insertion & decannulation of a catheter or the like is constituted by an elastic material which is flexible and has an appropriate strength, and there is employed a silicone rubber as an elastic material from a reason that poisonous property thereof to a living body is low or the like.

Before being used, the medical apparatus as mentioned above can be subjected to a sterilization process for killing & destroying or for removing microorganisms which exist on the front-face or inside of the apparatus. For the sterilization method, there can be cited, for example, a radiation sterilization of a gamma ray sterilization, an electron beam sterilization or the like; an ethylene oxide gas sterilization; a high-pressure steam sterilization (Autoclave Sterilization) and the like. Within those sterilizations, depending on a fact that processing time is short; continuous processing is possible and also post-processing is unnecessary, the radiation sterilization is suitable in the medical treatment site.

However, when executing radiation sterilization with respect to a medical apparatus which includes a silicone rubber, it happens that the silicone rubber will be hardened by the radiation irradiation and there existed such a problem that the desired elasticity thereof would be ruined.

### SUMMARY

The present inventors devoted themselves to conduct research to repress the hardening of the silicone rubber. In the process, it was found that the hardening of the silicone rubber can be repressed effectively by adding vitamin E to the silicone rubber, according to an exemplary aspect.

An example of a silicone rubber composition disclosed here involves vitamin E or a derivative thereof, or a salt of any one thereof being dispersed at least at a portion of the silicone rubber. According to one example, a silicone rubber composition is provided, comprising vitamin E, a derivative of vitamin E, a salt of vitamin E, or a salt of a derivative of vitamin E, dispersed at least at a portion of the silicone rubber.

According to another aspect disclosed by way of example here, a manufacturing method of a medical apparatus is provided including a process of mixing a silicone rubber precursor with vitamin E or a derivative thereof, or a salt of any one thereof and hardening the obtained mixture, or a process of infiltrating a silicone rubber into vitamin E or a derivative thereof, or a salt of any one thereof in a liquid state. According to another exemplary aspect, a method of manufacturing a silicone rubber composition is provided comprising: contacting a silicone rubber with vitamin E, a derivative of vitamin E, a salt of vitamin E, or a salt of a derivative of vitamin E, wherein the vitamin E is in a liquid state.

According to another exemplary aspect, a manufacturing method of a medical apparatus is provided including a process of installing the obtained silicone rubber composition onto a medical apparatus; a process of hermetically packaging the obtained medical apparatus; and a process of irradiating radiation to the hermetically packaged medical apparatus.

According to an exemplary aspect, it becomes possible to repress the hardening of the silicone rubber.

### BRIEF DESCRIPTION OF THE DRAWINGS

FIG. 1 is a graph showing exemplary results in which hardnesses were measured before sterilization and after sterilization with respect to silicone rubber compositions of inventive examples and of comparative examples.

### DETAILED DESCRIPTION

Hereinafter, aspects of the silicone rubber composition, manufacturing method and medical apparatus disclosed here will be explained.

### <Silicone Rubber Composition>

The silicone rubber composition of an exemplary embodiment has a feature in an aspect that vitamin E or a derivative thereof, or a salt of any one thereof (hereinafter, referred to also as “vitamin E or the like”) can be dispersed at least at a portion of the silicone rubber.

The silicone rubber in the past has a problem in which hardening occurs by irradiation of radiations such as a γ (gamma) ray, an electron beam and the like and the elasticity (flexibility) thereof will be lost. While not wishing to be bound by any particular theory, it is conceivable that this is caused by a mechanism as follows. When radiation is irradiated onto a silicone rubber, a radical is generated in the silicone rubber by a splitting of siloxane linkage, a pulling-out of a substitution group, a pulling-out of a hydrogen atom on the substitution group or the like. Then, caused by a phenomenon that the radical pairs link, an inner-molecule cross-link or an inter-molecule cross-link occurs and the motion of the molecules are restricted and the hardening is to occur.

In order to repress the hardening of such a silicone rubber, the present inventors attempted addition of various kinds of antioxidants which have radical capturing ability or radical scavenging ability. As a result thereof, it was not possible to obtain desired effects from a phenol-based antioxidant, a sulfur-based antioxidant, a phosphor-based antioxidant and the like which can be used as antioxidants for resins. On the other hand, in case of adding vitamin E or the like which can be used as an oxidation inhibitor in a living body, a remarkable hardening repression effect was obtained. In addition, it was comprehended that also the change of material property caused by the addition can be small, and an exemplary aspect was provided based on the aforesaid knowledge.

The scope of the present invention is to be defined depending on the claims and is not to be limited by the aforesaid mechanism. Hereinafter, it will be explained with respect to each constitution element of the silicone rubber composition of an exemplary embodiment.

### [Silicone Rubber]

There is no limitation in particular for the silicone rubber relating to an exemplary embodiment. For example, the silicone rubber can contain polysiloxane having rubber-like characteristics. The silicone rubber can be manufactured by cross-linking a polysiloxane polymer which is a silicone rubber precursor.

The silicone rubber relating to an exemplary embodiment can be a rubber formed by cross-linking a silicone rubber precursor which includes polyorganosiloxane (A) containing alkenyl groups and organohydrogenpolysiloxane (B). Hereinafter, the polyorganosiloxane (A) containing alkenyl groups is referred to also as “polysiloxane (A)” and the organohydrogenpolysiloxane (B) is referred to also as “polysiloxane (B)”.

Aforesaid polyorganosiloxane (A) containing alkenyl groups can be a polysiloxane which includes alkenyl groups linked to a silicon atom. The contained amount of the alkenyl group can be 0.005 mol % or more and, for example, 0.001 mol % to 1 mol % with respect to 1 mol of polysiloxane (A) molecules.

For the alkenyl group, there can be cited, for example, a vinyl group, an allyl group, propenyl group, a methallyl group, a butenyl group, a hexenyl group and the like. Within those groups, the alkenyl group can contain a vinyl group.

The aforesaid polysiloxane (A) can include a substitution group (e.g., organo group) other than the alkenyl group and there can be cited, for example, a substituted or unsubstituted alkyl group having 1 to 8 carbon atoms, a substituted or unsubstituted alkoxy group having 1 to 8 carbon atoms, a substituted or unsubstituted aryl group, a substituted or unsubstituted aralkyl group and the like.

For the alkyl group having 1 to 8 carbon atoms, for example, there can be cited a methyl group, an ethyl group, an n-propyl group, an isopropyl group, an n-butyl group, an isobutyl group, a sec-butyl group, a tert-butyl group, a hexyl group, an octyl group and the like. Within those groups, the alkyl group can contain a methyl group.

For the alkoxy group having 1 to 8 carbon atoms, for example, there can be cited a methoxy group, an ethoxyl group, an n-propoxy group, an isopropoxy group, an n-butoxy group, an isobutoxy group, a sec-butoxy group, a tert-butoxy group, a hexyloxy group, an octyloxy group and the like. For the aryl group, for example, there can be cited a phenyl group, a methylphenyl group and the like. For the aralkyl group, for example, there can be cited a benzyl group, a phenethyl group, a diphenylmethyl group and the like.

Also, for the alkenyl group, the alkyl group, the alkoxy group, the aryl group and the aralkyl group mentioned above, any of such groups can be substituted with, for example, a halogen atom, an acyl group, an alkyl group, a phenyl group, an alkoxyl group, an amino group, an alkylamino group, a carbonyl group, a cyano group and the like.

The polysiloxane (A) can be in any one of a straight chain shape, a branch chain shape and a ring shape. The shapes can be used singularly only by one kind thereof, or the shapes can be used by combining two kinds or more thereof.

The aforesaid organohydrogenpolysiloxane (B) can be a polysiloxane containing an average of at least two silicon bonded hydrogen atoms per molecule. The aforesaid two of hydrogens can be added to the double bond of the alkenyl group of the polyorganosiloxane (A) and form a cross-lingage structure.

Also, the polysiloxane (B) can include a substitution group (e.g., organo group) other than the hydrogen atom and there can be cited, for the substitution group, similar groups as illustrated by an example for the aforesaid polysiloxane (A). The polysiloxane (B) can be in any one of a straight chain shape, a branch chain shape and a ring shape. Also, the shapes can be used singularly only by one kind thereof, or the shapes can be used by combining two kinds or more thereof.

There is no limitation in particular for the ratio between the polysiloxane (A) and the polysiloxane (B) which are used when manufacturing the silicone rubber, but it can be preferable to select such a ratio in which the hydrogen atoms which link to the silicon atoms contained in the polysiloxane (B) become 0.5 mol to 3.0 mol with respect to 1 mol alkenyl group contained in the polysiloxane (A).

The silicone rubber of an exemplary embodiment can further contain a catalyst for cross-linking the polysiloxane which can be the silicone rubber precursor. There is no limitation in particular for the catalyst, but it can be preferable to be a platinum-based catalyst. For example, there can be cited a platinum black, a silica supported platinum, a carbon supported platinum, a platinum chloride acid, a platinum chloride acid alcohol solution, a platinum/olefin complex, a platinum/alkenylsiloxane complex, a platinum/β-diketone complex, a platinum/phosphine complex and the like, and a combination thereof. The aforesaid catalyst can be added so as to become approximately 0.1 ppm to 500 ppm (by Pt conversion) with respect to the gloss weight of the silicone rubber precursor.

Further, with respect to the silicone rubber of an exemplary embodiment, an inorganic filling material can be compounded other than the aforesaid component for the purpose of applying a hardness adjustment, an anti-heat reliability and an extending agent to the silicone rubber. With respect to the inorganic filling material, a material suitable for use with silicone rubber can be used such as, for example, a fumed silica and a precipitated silica, or surface-processed fine powdered silicas of those and in addition, powders of diatomites, quartzs, clays and the like, and a combination thereof.

### [Vitamin E, etc.]

The vitamin E or the derivative thereof, or the salt of any one thereof (vitamin E or the like) can have a function as an antioxidant which represses the cross-linking reaction as a radical capturing agent or as a radical scavenging agent in the silicone rubber composition of an exemplary embodiment.

For the aforesaid vitamin E, there can be cited, for example, α-tocopherol, β-tocopherol, γ-tocopherol, δ-tocopherol, α-tocotrienol, β-tocotrienol, γ-tocotrienol, δ-tocotrienol and the like, and a combination thereof. Each of those above can be any one of an optically active substance and a racemic substance. In addition, other than those tocopherols or tocotrienols, also analogous substances (e.g., compounds containing chromane rings or the like) of those above, which have oxidation protecting effect (antioxidative effect) can be used for the vitamin E in an exemplary embodiment.

For the aforesaid derivative of vitamin E, there can be cited an acetic ester, a nicotinic acid ester, a linoleic ester, a succinic acid ester and the like of the aforesaid vitamin E.

For the aforesaid salt of the vitamin E or of the derivative thereof, there is no limitation in particular. For example, the salt can be allowed physiologically and can include, for example, an alkaline metal salt of sodium, potassium or the like, an alkaline earth metal salt of calcium, magnesium or the like, an organic amine salt of triethanolamine, triethylamine or the like, an ammonium salt, a basic amino-acid salt of arginine, lysine or the like, and the like, and a combination thereof.

Within those vitamin E and the like, α-tocopherol or α-tocopherol acetate can be used from a viewpoint of oxidation-protection effect, and it can be more preferable to use α-tocopherol therein.

The silicone rubber of an exemplary embodiment can be formed by a configuration in which aforesaid vitamin E or the like is dispersed at least at a portion of aforesaid silicone rubber. There is no limitation in particular for the pattern of the dispersal, and a configuration can be employed in which the vitamin E is localized at a portion in the silicone rubber (for example, localized at a front face portion of the silicone rubber) or a configuration can be employed in which the vitamin E is dispersed uniformly all over the silicone rubber. In order to heighten the hardening-repression effect of the silicone rubber composition, it can be preferable to employ a configuration mode in which the vitamin E is dispersed uniformly all over the silicone rubber.

There is no limitation in particular for the contained amount of the vitamin E or the like which is contained in the silicone rubber composition of an exemplary embodiment. For example, the amount of vitamin E can be in a range which does not reduce the performance of the silicone rubber composition remarkably. From a viewpoint of the hardening-repression effect, the lower limit of the contained amount can be 0.1 Wt % or more with respect to the total mass of the silicone rubber, for example, 0.125 Wt % or more, for example, 0.5 Wt % or more. Also, from a viewpoint of maintaining the material property of the silicone rubber composition, the upper limit of the contained amount can be 10.0 Wt % or less with respect to the total mass of the silicone rubber, for example, 2.0 Wt % or less.

The silicone rubber composition of an exemplary embodiment can contain at least one kind of additive other than the silicone rubber and the vitamin E or the like in a range, for example, of not disturbing the effect of an exemplary embodiment significantly.

For the at least one additive, for example, there can be cited a crosslinking agent, a filling material, an ultraviolet-light absorber, a plasticizer, a coloring agent, an antistatic agent, a thermal stabilizing agent, an oxidation inhibitor, a light stabilizing agent, a flame retardant, a lubricant, an antioxidant, an antiaging agent, a reaction builder, a reaction inhibitor, a resin and the like, and a combination thereof.

### <Manufacturing Method of Silicone Rubber>

It is possible to manufacture the silicone rubber of an exemplary embodiment by (1) mixing a silicone rubber precursor with vitamin E or a derivative thereof, or a salt of any one thereof and hardening the obtained mixture, or by (2) infiltrating a silicone rubber into vitamin E or a derivative thereof, or a salt of any one thereof in a liquid state.

In the method of aforesaid (1), first, the silicone rubber precursor before the cross-linking, the vitamin E or the like, also an additive to be added if required and the like can be weighed out predetermined amount by predetermined amount, and these can be mixed by using a mixer device or the like and thereby making a state in which each component thereof is dispersed uniformly. For the mixer device, there can be used, for example, a mixing roll, a pressurizing kneader, a roller mill, a banbury mixer, a two-roll mixer, a three-roll mixer, a homogenizer, a ball mill, a beads mill and the like. Also, there is no limitation in particular for the temperature when executing the mixing, but it can be preferable to execute the mixing at 0° C. to 50° C. from a viewpoint of the oxidation protection of the vitamin E or the like. If required, the mixing can be executed under an inert gas atmosphere of nitrogen or the like for the purpose of the oxidation protection of the vitamin E or the like. Then, if required, by going further through a molding process and a hardening process, the obtained mixture can become a silicone rubber composition having a desired shape and a material property (for example, elastic property). The exemplary method is excellent in an aspect that it is easy to control the amount of the vitamin E or the like which is contained in the silicone rubber composition.

On the other hand, in the method of aforesaid (2), the silicone rubber after the cross-linking is infiltrated into a liquid-state vitamin E or the like and the vitamin E or the like can be introduced inside the silicone rubber. It can be preferable for the silicone rubber used in the exemplary method to use a silicone rubber which is mixed with necessary additives beforehand, is molded and is applied with a hardening process. In other words, it is possible, in an exemplary method, to directly use a silicone rubber member having a desired shape and material properties, which has been used in the past and then, it is possible to introduce vitamin E or the like therein, so that it can be more advantageous in this aspect compared with the method of (1). Then, this silicone rubber is infiltrated into a liquid-state vitamin E. On the occasion of this infiltration, it can be preferable to make a state in which the whole silicone rubber contacts with the vitamin E or the like. Also, the temperature and the duration of the infiltration can be adjusted depending on the size and the shape of the silicone rubber. For example, in an exemplary embodiment, vitamin E or the like can be effectively introduced into the inside of the silicone rubber generally by executing the infiltration for 1 to 500 hours at the temperature of 0° C. to 150° C. In particular, the introduction of the vitamin E or the like can be accelerated by heightening the temperature of the infiltration. Also, for the vitamin E or the like used in an exemplary method, it can be preferable to use α-tocopherol whose fusion point is 2.5° C. to 3.5° C., whose boiling point is 200° C. to 220° C. and which is liquid at a normal (e.g., room) temperature. If required, the infiltration can be executed under an inert gas atmosphere of nitrogen or the like for the purpose of oxidation protection of the vitamin E or the like.

### <Medical Apparatus>

Based on a fact that the aforesaid silicone rubber composition will be hardened little or not hardened due to the radiation irradiation in an exemplary embodiment, it can be suitably used as an elastic material of a medical apparatus which is applied with a radiation sterilization process. Accordingly, also provided is a medical apparatus including the aforesaid silicone rubber composition.

Although it is not limited by the description hereinafter, for the medical apparatus, there can be cited such as, for example, a catheter; a tube; an introducer used when introducing a long-size member of a catheter, a guide wire or the like into the inside of a living body; a body-liquid circuit of an artificial heart, a blood circuit, an artificial dialysis or the like; a sticking plug to be stuck by an injection needle or the like; a cap of a medicine bottle and the like. In those medical apparatuses, the silicone rubber composition can be used, for example, as a balloon of a catheter; a hemostatic valve of an introducer; an elastic material of a packing of a body-liquid circuit; or an O ring and a connector of various kinds of apparatuses.

The aforesaid medical apparatus can be manufactured by using a similar method as that in the past other than installing the silicone rubber composition according to an exemplary aspect into the main body of the medical apparatus.

### <Sterilization Process>

According to an exemplary aspect, there is provided a manufacturing method of a medical apparatus, which further includes a sterilization process by irradiating radiation after hermetically packaging the aforesaid medical apparatus.

The dose of the irradiated radiation can depend on the aimed product and is not to be limited in particular, but it can be 5 kGy to 100 kGy and preferably, 10 kGy to 60 kGy.

With respect to the kinds of the irradiating radiations, it is possible to use an electron beam, a γ (gamma) ray, an X ray and the like. Within those kinds, based on a fact that industrial production thereof is easy, it can be preferable to use an electron beam by an electron accelerator or a γ ray from cobalt-60 m, in which the electron beam can be more preferable. With respect to the electron accelerator, in order to make the irradiation possible even until the inside of the medical apparatus or the like having a comparatively thick portion, it can be preferable to use an electron accelerator having energy from medium energy to high energy of acceleration voltage 1 MeV or more.

It is not limited in particular by the irradiation atmosphere of the ionizing radiation, but the irradiation can be executed under an inert atmosphere without air or under vacuum. Also, the ionizing radiation can be irradiated after hermetically sealing the medical apparatus by a packaging material and also in that case, the inside of the packaging material can be filled up by air or by inert gas, or can be in a vacuum state. The temperature at the time of irradiation can be selected to be any temperature, for example, room temperature.

### INVENTIVE EXAMPLES

The action & effect of exemplary aspects will be explained by using the following inventive examples and comparative examples. However, it does not mean that the technical scope of the present invention is to be limited only by the following inventive examples.

### <Preparation of Silicone Rubber Composition>

### Inventive Example 1

Each of 100 parts by weight of A-agent and B-agent of a millable type silicone rubber (MED of NuSil Technology LLC or SILASTIC of Dow Corning Corporation) was kneaded and softened at a room temperature beforehand. 100 parts by weight of the A-agent was added with 0.125 parts by weight of α-tocopherol (by DMS Corp.) (0.125 Wt % with respect to the total mass of the silicone rubber) and they were mixed at a room temperature. Subsequently, the 100 parts by weight of B-agent was added thereto and they were further mixed.

The obtained mixture was sheet-formed such that the thickness thereof became 2 mm and it was hardened by applying thermal treatment for 10 minutes at 116° C., and a silicone rubber composition was prepared.

### Inventive Example 2

A silicone rubber composition was prepared by a similar method as that of the inventive example 1 other than a fact that the additive amount of the α-tocopherol was made to be 0.5 parts by weight (0.5 Wt % with respect to the total mass of the silicone rubber).

### Inventive Example 3

A silicone rubber composition was prepared by a similar method as that of the inventive example 1 other than a fact that the additive amount of the α-tocopherol was made to be 2.0 parts by weight (2.0 Wt % with respect to the total mass of the silicone rubber).

### Inventive Example 4

Without adding the α-tocopherol, a silicone rubber composition was prepared by a similar method as that of the inventive example 1.

Also, with respect to the obtained silicone rubber, a tensile strength test piece was produced in conformity to (ASTM D 638-97). Also, a tear strength test piece was produced in conformity to (ASTM D 624-00).

The obtained test piece was put into a glass container and the α-tocopherol was added therein by such an amount that the test piece is covered sufficiently, and the glass container was closed by a lid. By placing this container stationarily in an oven of 60° C. for 9 days, the silicone rubber was infiltrated into the α-tocopherol.

Thereafter, the test piece was taken out, the α-tocopherol attached on the front face thereof was cleaned off, and a test piece of the silicone rubber composition was obtained.

When the mass of the obtained test piece was compared with that before the infiltration in order to measure the contained amount of the α-tocopherol which was contained in the aforesaid silicone rubber composition, the α-tocopherol was contained by an amount of 1 to 2 Wt % with respect to the silicone rubber.

### Comparative Example 1

Other than that the α-tocopherol was not added, the silicone rubber composition was prepared by a similar method as that of the inventive example 1.

### Comparative Example 2

The silicone rubber composition was prepared by a similar method as that of the inventive example 4 excluding a fact that the α-tocopherol was not added in the glass container.

### Comparative Example 3

The silicone rubber composition was prepared by a similar method as that of the inventive example 1 excluding a fact that an Irganox° 1076 was used instead of the α-tocopherol.

### Comparative Example 4

The silicone rubber composition was prepared by a similar method as that of the inventive example 2 excluding a fact that the Irganox° 1076 was used instead of the α-tocopherol.

### Comparative Example 5

The silicone rubber composition was prepared by a similar method as that of the inventive example 3 excluding a fact that the Irganox° 1076 was used instead of the α-tocopherol.

### Comparative Example 6

The silicone rubber composition was prepared by a similar method as that of the inventive example 4 excluding a fact that the Irganox° 1076 was used instead of the α-tocopherol.

### Comparative Example 7

The silicone rubber composition was prepared by a similar method as that of the inventive example 1 excluding a fact that a 3,3-thiodipropionic acid ditridecyl was used instead of the α-tocopherol.

### Comparative Example 8

The silicone rubber composition was prepared by a similar method as that of the inventive example 2 excluding a fact that the 3,3-thiodipropionic acid ditridecyl was used instead of the α-tocopherol.

### Comparative Example 9

The silicone rubber composition was prepared by a similar method as that of the inventive example 3 excluding a fact that the 3,3-thiodipropionic acid ditridecyl was used instead of the α-tocopherol.

### Comparative Example 10

The silicone rubber composition was prepared by a similar method as that of the inventive example 4 excluding a fact that the 3,3-thiodipropionic acid ditridecyl was used instead of the α-tocopherol.

### Comparative Example 11

The silicone rubber composition was prepared by a similar method as that of the inventive example excluding a fact that a Doverphos® S-9228 was used instead of the α-tocopherol.

### Comparative Example 12

The silicone rubber composition was prepared by a similar method as that of the inventive example excluding a fact that the Doverphos® S-9228 was used instead of the α-tocopherol.

### Comparative Example 13

The silicone rubber composition was prepared by a similar method as that of the inventive example 1 excluding a fact that an active carbon (Nuchar® RGC powder; manufactured by Westvaco Corp.) was used instead of the α-tocopherol.

### Comparative Example 14

The silicone rubber composition was prepared by a similar method as that of the inventive example 2 excluding a fact that the active carbon was used instead of the α-tocopherol.

### Comparative Example 15

The silicone rubber composition was prepared by a similar method as that of the inventive example 3 excluding a fact that the active carbon was used instead of the α-tocopherol.

### Comparative Example 16

The silicone rubber composition was prepared by a similar method as that of the inventive example 1 excluding a fact that a C60 fullerene (manufactured by Nano-C Inc.) was used instead of the α-tocopherol.

### Comparative Example 17

The silicone rubber composition was prepared by a similar method as that of the inventive example 2 excluding a fact that the C60 fullerene (manufactured by Nano-C Inc.) was used instead of the α-tocopherol.

### Comparative Example 18

The silicone rubber composition was prepared by a similar method as that of the inventive example 3 excluding a fact that the C60 fullerene (manufactured by Nano-C Inc.) was used instead of the α-tocopherol.

### Comparative Example 19

The silicone rubber composition was prepared by a similar method as that of the inventive example 1 excluding a fact that a barium sulfate (manufactured by Alfa Aesar) was used instead of the α-tocopherol.

### Comparative Example 20

The silicone rubber composition was prepared by a similar method as that of the inventive example 2 excluding a fact that the barium sulfate (manufactured by Alfa Aesar) was used instead of the α-tocopherol.

### Comparative Example 21

The silicone rubber composition was prepared by a similar method as that of the inventive example 3 excluding a fact that the barium sulfate (manufactured by Alfa Aesar) was used instead of the α-tocopherol.

### <Sterilization Process>

At a room temperature, an electron beam 60 kGy was irradiated by using a 10 MeV electron accelerator.

### <Performance Evaluation>

### [Hardness]

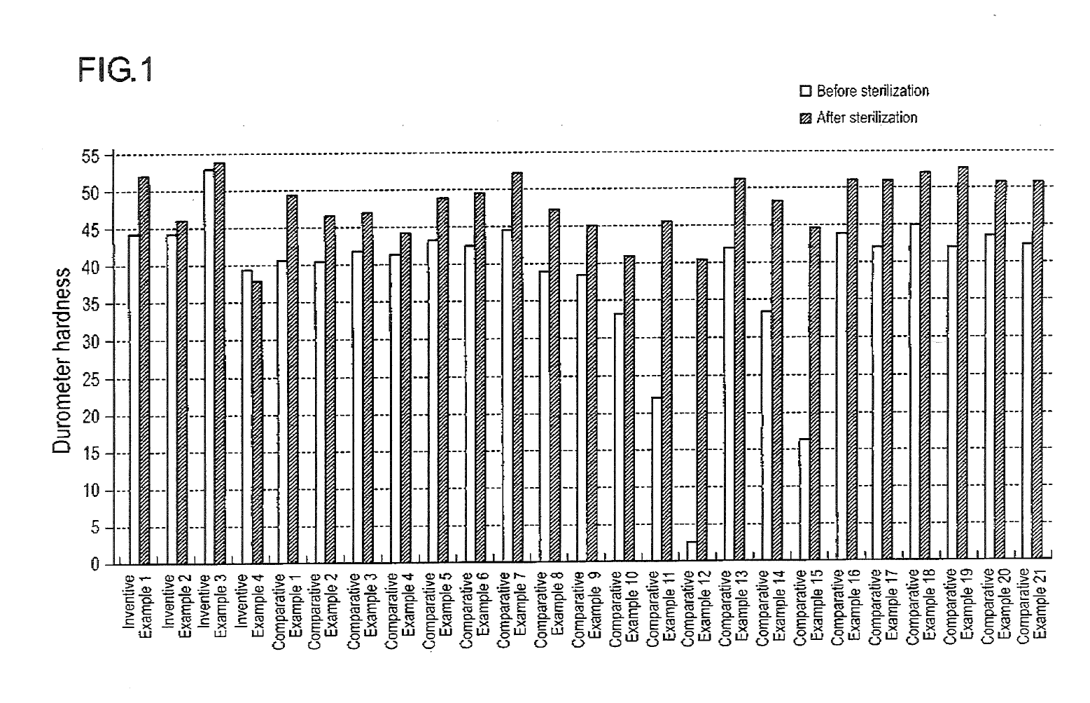

With respect to the silicone rubber compositions obtained by the inventive examples 1 to 4 and the comparative examples 1 to 21, the hardnesses thereof were measured in conformity to ASTM D 2240-05 (published in July, 2005). For the measurement, there was used a Durometer A-2 (manufactured by Shore Corp.). The result thereof is shown in FIG. 1.

According to the graph of FIG. 1, with respect to the silicone rubber compositions of the inventive examples 1 to 3, which were obtained by mixing the silicone rubber and the α-tocopherol, it was shown that the increase of the hardness thereof after the electron beam irradiation was repressed compared with that of the comparative example 1 in which the α-tocopherol was not added and that the effect thereof became more remarkable as the additive amount of the α-tocopherol was increased. The changes of the hardness thereof before the electron beam irradiation were small. Also, with respect to the silicone rubber composition of the inventive example 4, which was obtained by infiltrating the silicone rubber into the α-tocopherol, it was shown that the increase of the hardness thereof after the electron beam irradiation was repressed compared with that of the comparative example 2 in which there was no infiltration into the α-tocopherol and that the change of the hardness thereof before the electron beam irradiation was small.

On the other hand, with respect to the comparative examples 3 to 6 in which the Irganox1076 was used, there was recognized no repression effect for the increases of the hardnesses thereof after the electron beam irradiation and further, it happened that the hardnesses thereof increased along with the increase of the additive amount thereof. Further, there was confirmed the increase of the hardness thereof also before the electron beam irradiation.

With respect to the comparative examples 7 to 10 in which the 3,3-thiodipropionic acid ditridecyl was added; the comparative examples 11 and 12 in which the Doverphos® S-9228 was added and the comparative examples 13 to 15 in which the active carbon was added, it happened that the material properties thereof changed significantly such as a fact that the strength of the silicone rubber was lowered significantly before the electron beam irradiation and the like.

Also, with respect to the comparative examples 16 to 18 in which the 060 fullerene was added and the comparative examples 19 to 21 in which the barium sulfate was added, there was recognized no repression effect for the increase of the hardness thereof caused by the electron beam irradiation.

### [Tensile Strength]

With respect to the silicone rubber compositions obtained by the inventive examples 1 to 3 and the comparative example 1, the tensile strengths thereof were measured in conformity to ASTM D 638-97 (published in April, 1998). Elastic moduli thereof were calculated between 1000% and 1500%. For the measurement, there was used a MiniBionix II model 858 (manufactured by MTS Systems Corp.). The results thereof are shown in the following Table 1.

TABLE 1
Elasticity Coefficient Versus Tensile Stress

| | | Elastic Modulus | |
|---|---|---|---|
| | Additive Amount | [KPa] | |
| | of α-tocopherol | Before | After |
| | [Wt %] | Irradiation | Irradiation |
| Inventive Example 1 | 0.125 | 1.09 | 3.02 |
| Inventive Example 2 | 0.5 | 1.14 | 2.79 |
| Inventive Example 3 | 2.0 | 1.13 | 2.44 |
| Comparative Example 1 | 0 | 1.14 | 3.92 |

According to Table 1, with respect to the silicone rubber compositions of the inventive examples 1 to 3, it was shown that increase of the tensile strengths thereof after the electron beam irradiation were remarkably repressed compared with that of the comparative example 1 in which the α-tocopherol was not added. Further, the more the additive amount of the α-tocopherol became, the larger the effect thereof became.

### [Tear Strength]

With respect to the silicone rubber composition obtained by the inventive examples 2 to 3 and the comparative example 1, tear strengths thereof were measured in conformity to ASTM D 624-00 (published in July, 2000). For the measurement, there was used a MiniBionix II model 858 (manufactured by MTS Systems Corp.). The result thereof is shown in the following Table 2.

TABLE 2
Tear Strength

| | | Elastic Modulus | |
|---|---|---|---|
| | Additive Amount | [KPa] | |
| | of α-tocopherol | Before | After |
| | [Wt %] | Irradiation | Irradiation |
| Inventive Example 2 | 0.5 | 31.0 | 30.0 |
| Inventive Example 3 | 2.0 | 27.1 | 27.8 |
| Comparative Example 1 | 0 | 30.2 | 20.8 |

According to Table 2, with respect to the silicone rubber compositions of the inventive examples 2 to 3, it was shown that the decrease of the tear strengths thereof after the electron beam irradiation were repressed compared with that of the comparative example 1 in which the α-tocopherol was not added.

Having described preferred embodiments of the silicone rubber composition with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A silicone rubber composition, comprising vitamin E, a derivative of vitamin E, a salt of vitamin E, or a salt of a derivative of vitamin E, dispersed at least at a portion of the silicone rubber.

2. The silicone rubber composition according to claim 1, wherein a contained amount of the vitamin E, derivative of vitamin E, salt of vitamin E, or salt of a derivative of vitamin E, is 0.1 Wt % to 10.0 Wt % with respect to the total mass of the silicone rubber.

3. The silicone rubber composition according to claim 1, wherein the vitamin E is α-tocopherol.

4. The silicone rubber composition according to claim 2, wherein the vitamin E is α-tocopherol.

5. The silicone rubber composition according to claim 1, wherein
the silicone rubber is formed by a rubber in which a silicone rubber precursor is cross-linked, and
the silicone rubber precursor includes a polyorganosiloxane containing alkenyl groups and an organohydrogenpolysiloxane.

6. The silicone rubber composition according to claim 2, wherein
the silicone rubber is formed by a rubber in which a silicone rubber precursor is cross-linked, and
the silicone rubber precursor includes a polyorganosiloxane containing alkenyl groups and an organohydrogenpolysiloxane.

7. The silicone rubber composition according to claim 3, wherein
the silicone rubber is formed by a rubber in which a silicone rubber precursor is cross-linked, and
the silicone rubber precursor includes a polyorganosiloxane containing alkenyl groups and an organohydrogenpolysiloxane.

8. A method of manufacturing a silicone rubber composition comprising:
mixing a silicone rubber precursor with vitamin E, a derivative of vitamin E, a salt of vitamin E, or a salt of a derivative of vitamin E; and
hardening the obtained mixture.

9. A method of manufacturing a silicone rubber composition comprising:
infiltrating a silicone rubber into vitamin E, a derivative of vitamin E, a salt of vitamin E, or a salt of a derivative of vitamin E, wherein the vitamin E is in a liquid state.

10. A medical apparatus comprising the silicone rubber composition according to claim 1.

11. A medical apparatus comprising the silicone rubber composition according to claim 2.

12. A medical apparatus comprising the silicone rubber composition according to claim 3.

13. A medical apparatus comprising the silicone rubber composition according to claim 4.

14. A medical apparatus comprising the silicone rubber composition according to claim 5.

15. A medical apparatus comprising the silicone rubber composition according to claim 6.

16. A medical apparatus comprising the silicone rubber composition according to claim 7.

17. A medical apparatus comprising the silicone rubber composition obtained from the method according to claim 8.

18. A medical apparatus comprising the silicone rubber composition obtained from the method according to claim 9.

19. A method of manufacturing a medical apparatus comprising:
mixing a silicone rubber precursor with vitamin E, a derivative of vitamin E, a salt of vitamin E, or a salt of a derivative of vitamin E, and hardening the obtained mixture; or infiltrating a silicone rubber into vitamin E, a derivative of vitamin E, a salt of vitamin E, or a salt of a derivative of vitamin E, wherein the vitamin E is in a liquid state;
installing the obtained silicone rubber composition onto a medical apparatus;
hermetically packaging the obtained medical apparatus; and
irradiating the hermetically packaged medical apparatus with radiation.

20. A method of manufacturing a silicone rubber composition comprising:
contacting a silicone rubber with vitamin E, a derivative of vitamin E, a salt of vitamin E, or a salt of a derivative of vitamin E, wherein the vitamin E is in a liquid state.
